(19) United States
(12) Patent Application Publication
(10) Pub. No.: US 2017/0027271 A1
(43) Pub. Date: Feb. 2, 2017

(54) INTERACTIVE SHOE

(71) Applicant: Lindsay Michelle Ferencz, Westland, MI (US)

(72) Inventor: Lindsay Michelle Ferencz, Westland, MI (US)

(21) Appl. No.: 14/810,608

(22) Filed: Jul. 28, 2015

(51) Int. Cl. A43B 3/00; G05B 15/02; G06F 3/16; G09B 5/04

(52) U.S. Cl. CPC A43B 3/0021; A43B 3/001; G09B 5/04; G05B 15/02; G06F 3/165

(57) ABSTRACT

A shoe for use in motivating and teaching children or adults comprises a sole and an upper connected to the sole. The shoe further comprises a tongue connected at one end to the upper. The shoe also comprises an electronic device arranged in the upper or the tongue, wherein the electronic device plays music, teaches and motivates the shoe user.

### BACKGROUND OF THE INVENTION

1. Field of the Invention

The invention generally relates to shoes, and more particularly relates to an interactive learning and motivational shoe for children.

2. Description of Related Art

Shoes and tennis shoes have been known in the prior art for many years. A general prior art shoe includes a sole, an upper, and a tongue attached to the upper, along with a toe cap on one end and a heel counter and pull tab on the opposite end. These general components make up the anatomy of a shoe. Shoe manufacturers over the years have been introducing to the public an array of new technologies for shoes, such as in the area of children shoes, i.e., shoes that light when children run thus creating a fun shoe for children to wear, where lights are either arranged in the upper or sole of the shoes and emit different colors upon each step taken by a child. Other prior art shoe accessories, such as clips, tokens, etc., have also been introduced by shoe manufactures to gain the attention of children and teens in order to sway such consumers to a particular brand of shoe.

However, there is a need in the art for a shoe, such as a tennis shoe for children, that may be a learning shoe that is interactive and may help to improve the overall life skills of a child. There also is a need in the art for an interactive shoe for children that would teach, motivate, and track the learning of motor skills and other milestones. There also is a need in the art for an interactive shoe that may include an electronic device arranged either in a tongue or an upper of the shoe. There also is a need in the art for an interactive shoe that may include a plurality of lights that may flash to the beat of the music being played by an electronic device arranged thereon. There also is the need in the art for an interactive shoe that may be capable of streaming music and having batteries on board, such as a rechargeable battery, to ensure long uninterrupted use for the interactive shoes. There also is a need in the art for an interactive shoe that may play songs, vibrate at predetermined intervals, teach and motivate young children and build young children's motor skills while also promoting exercise and other life skills.

### SUMMARY OF THE INVENTION

One object of the present invention may be to provide an improved shoe.

Another object of the present invention may be to provide an improved interactive shoe for children.

Still another object of the present invention may be to provide an interactive shoe that includes an electronic device arranged in a tongue or an upper of the shoe.

Still another object of the present invention may be to provide an interactive shoe that is capable of playing songs or other programs in order to motivate, teach, and entertain children and adults.

Still another object of the present invention may be that it provides an interactive shoe that includes at least one button arranged thereon capable of turning the interactive shoe on and off, adjusting the volume, and choosing a particular program to run thereon.

Still another object of the present invention may be to provide an interactive shoe that incorporates a speaker directly into the shoe in order to play music or other programs via an electronic device for motivating and learning of the wearer of the shoe.

To achieve the foregoing objects and other advantages an interactive shoe for use in motivating and teaching is disclosed. The interactive shoe comprises a sole and an upper connected to the sole. The interactive shoe further comprises a tongue connected at one end to the upper and an electronic device arranged in the upper or the tongue. The electronic device is capable of playing music, teaching, and motivating the shoe user through any predetermined number of programs stored on or streamed to the electronic device.

One advantage of the present invention may be that it provides a novel and improved shoe.

Still another advantage of the present invention may be that it provides a novel and improved interactive shoe for children or adults.

Yet another advantage of the present invention may be that it provides an interactive shoe that includes an electronic device arranged at a predetermined position on the shoe.

Yet another advantage of the present invention may be that it provides an interactive shoe that has a plurality of programs stored thereon or streamed to an electronic device in order to motivate and teach the user of the shoe.

Still another advantage of the present invention may be that it provides an interactive shoe that is capable of playing songs, teaching motor skills, dance, sing, exercise, play games, etc.

Still another advantage of the present invention may be that it provides an interactive shoe that includes a speaker through which programs on an electronic device of the shoe may be played.

Still another advantage of the present invention may be that it provides an interactive shoe that includes a plurality of buttons, such as an on/off button, a volume button, a skip button, or any other known buttons to control and operate the electronic device arranged thereon.

Still another advantage of the present invention may be that it provides an interactive shoe that includes a rechargeable battery arranged within an electronic device, the sole of the shoe or any other portion of the shoe.

Yet another advantage of the present invention may be that it provides an interactive shoe that may interact with other interactive shoes worn by another user.

Still another advantage of the present invention may be that it provides an interactive shoe that includes a plurality of lights arranged at a predetermined position thereon, the lights may vibrate and flash to the beat of the music being played by the interactive shoe.

Other objects, features and advantages of the present invention may become apparent from the subsequent description and the appended claims, taken in conjunction with the accompanying drawings.

### BRIEF DESCRIPTION OF THE DRAWINGS

FIG. 1 shows a side view of an interactive shoe according to the present invention.

FIG. 2 shows a view of an electronic device according to an embodiment of the present invention.

FIG. 3 shows a side view of an interactive shoe according to an alternate embodiment of the present invention.

FIG. 4 shows an electronic device for an interactive shoe according to an alternate embodiment of the present invention.

FIG. 5 shows a top view of an interactive shoe according to an alternate embodiment of the present invention.

FIG. 6 shows a side view of the interactive shoe shown in FIG. 5.

FIG. 7 shows a side view of an interactive shoe according to an alternate embodiment of the present invention.

FIG. 8 shows a side view of an interactive shoe according to an alternate embodiment of the present invention.

FIG. 9 shows a speaker for use with an interactive shoe according to the present invention.

FIG. 10 shows a bottom view of a speaker according to an embodiment of the present invention.

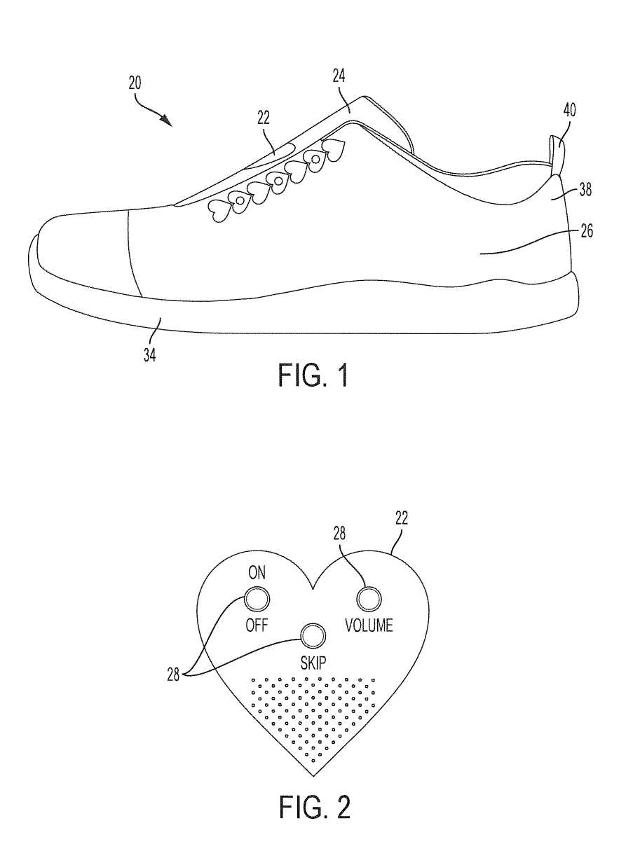

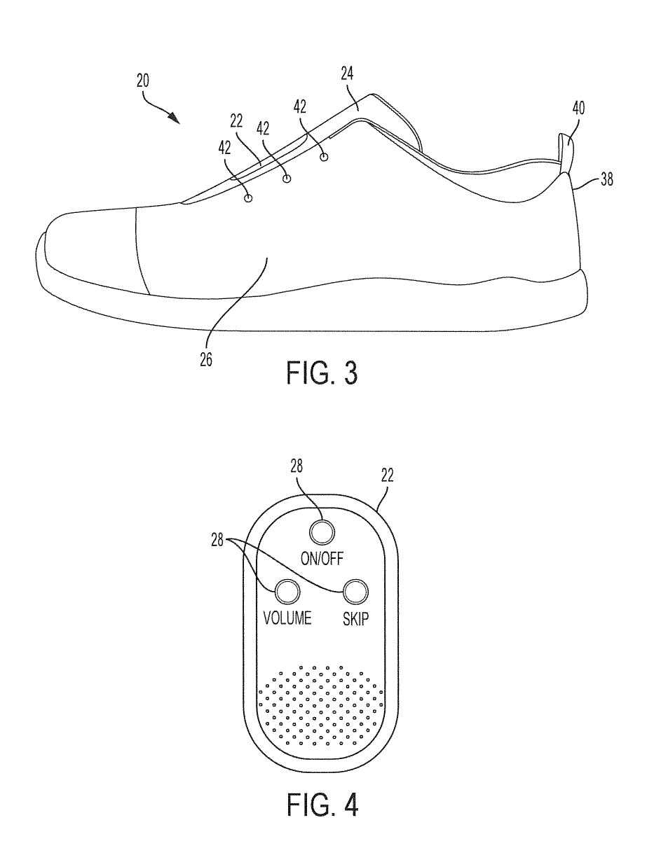

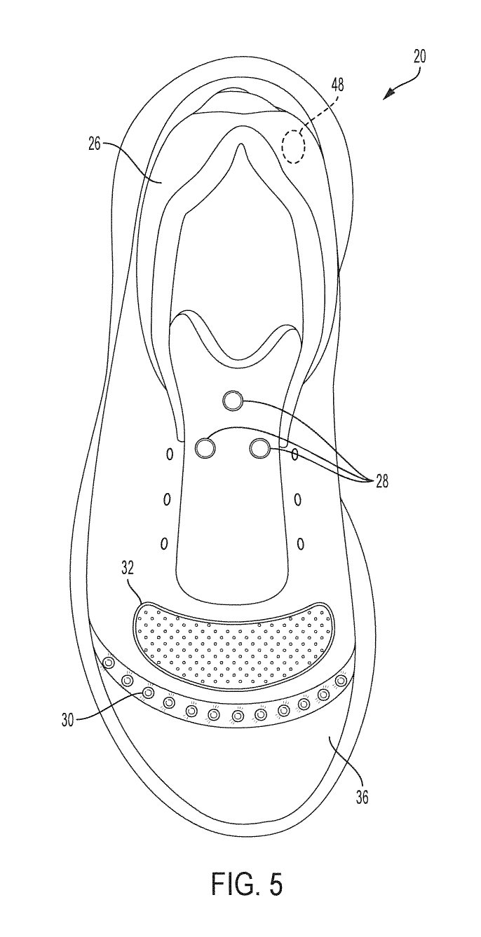

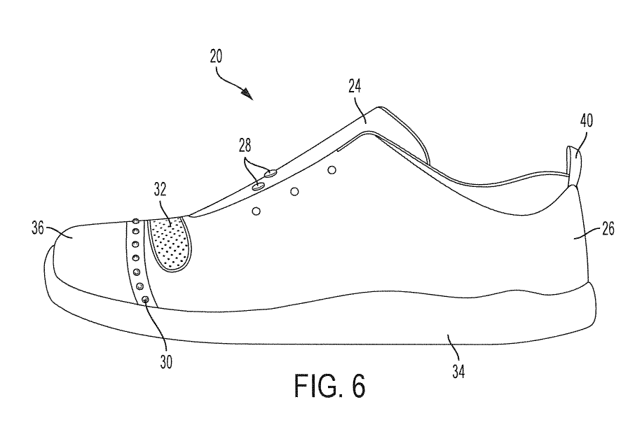

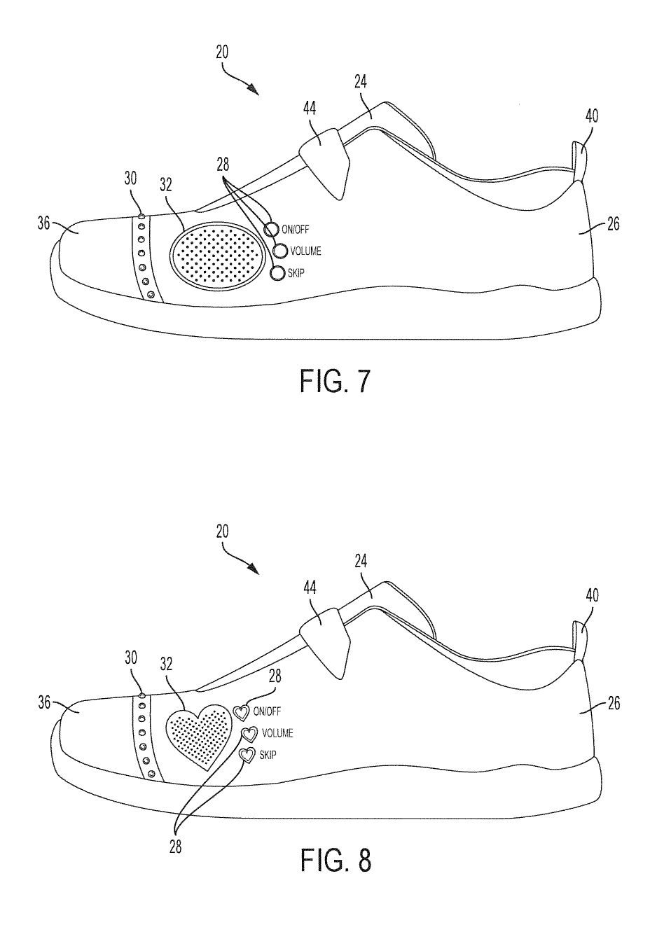

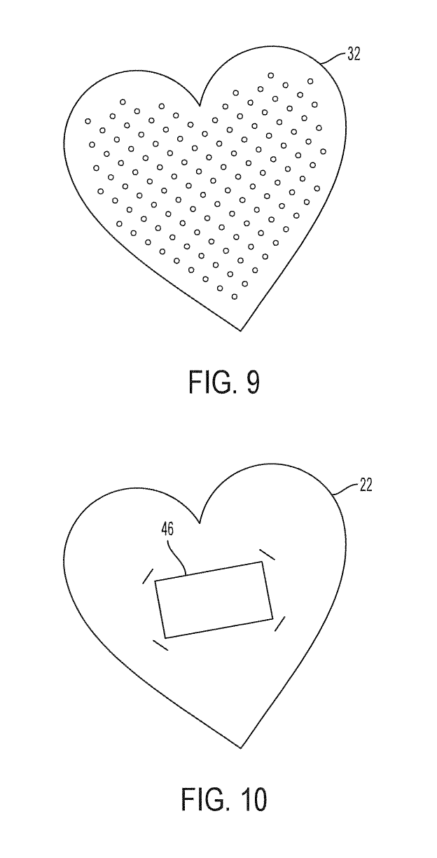

### DESCRIPTION OF THE EMBODIMENT(S)

Referring to the drawings, an interactive shoe 20 for use by a child or adult is disclosed. The interactive shoe 20 of the present invention may be a motivational learning shoe that is capable of playing programs associated with a multitude of teaching and motivational situations or parameters. The interactive shoe 20 of the present invention may include an electronic device 22 arranged on a tongue 24 or upper 26 of the interactive shoe 20. The interactive shoe 20 of the present invention may be motivational and teaching shoes that are capable of playing motivational speeches, learning songs, fun songs, brain stimulating games, teach motor skills, promote fun, play games, exercise, teach physical therapy programs, dancing, singing, vocal therapy programs, teach fitness routines, etc., to the user/wearer of the interactive shoe 20. The interactive shoe 20 may also be capable of providing an exercise regiment, teach memory skills, play riddles, play character songs, lullaby songs, nursery rhythms, and also teach different languages to the users of the interactive shoes 20. The electronic device 22 which is arranged on the interactive shoe 20 may be capable of storing any number of programs or streaming such programs directly thereto via a computer, handheld electronic device, phone, etc. In one contemplated embodiment, the interactive shoe 20 of the present invention, which is preferably a tennis shoe, however any other known shoe such as but not limited to flats, sneakers, skater shoes, slippers, boots, dress shoes, work shoes, or any other type of shoe capable of being worn by a child or adult may be capable of having the electronic device 22 arranged thereon, thus creating the interactive shoe 20 according to the present invention. The interactive shoe 20 of the present invention may have a plurality of buttons 28 arranged therein to create for an easy to use on/off switch, volume switch, and skip/play or select button to choose a predetermined program for use by the shoe wearer, such as a child or adult. The interactive shoe 20 of the present invention may also have a character motif on the shoe, such as Disney characters, Marvel characters, or any other type of character. The interactive shoe 20 and the associated electronic device 22 arranged thereon, is capable of playing any type of music, either stored thereon or streamed thereto, thus making it a hands free interactive shoe 20. It is contemplated in one embodiment that no other devices or wires may be needed to operate the interactive shoe 20. In another contemplated embodiment the interactive shoe 20 may also include lights 30 that may flash to the beat of music and/or to vibrations of the interactive shoe 20. The interactive shoe 20 may include at least one speaker 32 arranged thereon and it is contemplated that the speaker may be a Bluetooth speaker or a traditional speaker. The interactive shoe 20 of the present invention may also provide for a comfortable play shoe for children to learn and be motivated to increase their motor skills, language skills or any other skills being taught. It is also contemplated to have the interactive shoe 20 capable of being operated in any known language, such that children and adults of different countries may be capable of using the interactive shoes to play music, to learn and/or be motivated. It is also contemplated that the interactive shoes 20 may be capable of interacting with another pair of shoes 20 worn by another child, such as a pair of character shoes being worn by a child who may interact with another pair of like character shoes to allow a plurality of children to play with each other while their interactive shoes 20 interact with each other to motivate and allow for fun skill/team building.

As shown in the Figures, an interactive shoe 20 according to the present invention is disclosed. The interactive shoe 20 of the present invention generally is a tennis shoe. The interactive shoes 20 shown generally are designed for children to wear such that motivational and teaching skills may be transmitted from the shoe 20 directly to the child wearing the shoes. The interactive shoe 20 generally may include a sole 34 on a bottom surface thereof and an upper 26 connected to the top surface of the sole 34 of the shoe 20. The interactive shoe 20 may further include a tongue 24 connected on one end to a front portion of the upper 26 of the interactive shoe 20. The interactive shoe 20 may also include near the front end of the upper 26 a toe cap 36 and a heal counter 38 at a rear end of the upper 26. Also, near or at the rear end of the upper 26 of the interactive shoe 20 may be a pull tab 40, which allows for easier taking on and off of the shoe 20 by the user. It should be noted that in one contemplated embodiment, the interactive shoe 20 may be a slip on shoe, which allows for easy removal and placement of the shoe on the foot of the wearer. However, it should be noted that it is also contemplated to have a plurality of eyelets 42 arranged along an edge of the upper 26 to allow for laces or shoe strings 44 to be used to tie and secure the shoe to the foot of the wearer. It is also contemplated to use elastic or Velcro 44 to secure the shoe to the foot of the wearer. Generally, the Velcro 44 may be arranged near a top end of the upper 26 across a gap formed in the upper 26 wherein the tongue 24 of the shoe 20 is arranged. It should further be noted that the interactive shoe 20 may be made of any known material, such as the upper 26 and tongue 24 maybe made of leather, plastic, cloth, vinyl or any other known natural or manmade material. It is also contemplated to have a foam type of padding arranged on the tongue 24 and on the top surface of the sole 34 to allow for a comfortable fit of the shoe 20 for the wearer. The sole 34 of the shoe 20 generally may be made from a rubber or other type of plastic material, however any other known material may also be used for the sole 34 of the shoe 20. The interactive shoes 20 may have any variety of colors and any other type of design, logos or characters arranged on the outside surface of the shoes 20 to make for a more aesthetically pleasing and interesting shoe 20 for the wearer, such as children and Disney characters or the like. In one contemplated embodiment, the interactive shoe 20 may be waterproof thus allowing for the shoe to be used in the rain, while swimming or the like. As noted above, the interactive shoe 20 may come in any known color and may have the same color or different color on both the sole 34 and upper 26. The sole 34 of the shoe 20 may also be made in any known color with any known type of tread pattern arranged on the bottom outside surface of the sole 34.

The interactive shoe 20 of the present invention may also include an electronic device 22 arranged or secured to the tongue 24 or the upper 26 of the interactive shoe 20. The electronic device 22 may be capable of storing or streaming a plurality of programs therethrough to be used by the wearer of the shoe 20. The plurality of programs may allow the shoe 20 to be interactive, thus creating a motivational and teaching environment for the wearer of the shoes 20. The electronic device 22 may be controlled via an integrated circuit 46 that may have the requisite resistors, capacitors, diodes, and other electronic components thereon to allow for the ability for programs to be played in an interactive manner, such that the wearer of the shoes is capable of following along with instructions or listens to songs, other motivational speeches, etc., via the electronic system of the electronic device 22. The electronic device 22 may have any known shape. In one contemplated embodiment, the electronic device 22 may have a heart shape, an oval shape, however any other known shape such as square, triangular, any random shape, etc., may also be used for the electronic device 22. The electronic device 22 may be sewn directly into the tongue 24 or upper 26 of the shoe 20 according to one embodiment. However, it is also contemplated that the electronic device 22 may be glued or secured via any other known chemical fastening or mechanical fastening technique to the tongue 24 or upper 26 of the shoe 20. The electronic device 22 may be arranged at any predetermined position on the upper 26 or the tongue 24 of the shoe 20 in order to allow for the shoe 20 to still be comfortable during walking, running and overall use by the wearer of the shoe. Generally, the electronic device 22 may be made of a plastic material, however any other known metal, composite or natural material, etc., may be used to form the electronic device 22 and the associated electronic hardware arranged therein. The electronic device 22 in one contemplated embodiment may have a battery arranged directly on board, wherein that battery may be available to be replaced via a door or cover arranged on the electronic device 22. It is also contemplated to use a rechargeable battery 48 in the interactive shoe 20 according to the present invention. The rechargeable battery 48 may be located directly on the electronic device 22 or be located directly in another portion of the shoe 20 such as within the sole 34 of the shoe 20. In the case of a rechargeable battery 48 arranged in the sole 34 of the shoe 20 an electronic socket may be arranged at a predetermined position on a side surface of the sole 34, such as at the back of the sole 34. This socket may then be capable of receiving a male plug that is connected to an electrical outlet to allow for recharging of the battery 48 arranged within the sole 34 of the shoe 20. It is also contemplated to have the rechargeable battery 48 arranged directly within the electronic device 22 and the electronic device to be a socket that is capable of receiving a male end of a recharger connected to an electrical outlet. This may allow for the rechargeable battery 48 to be used with the interactive shoe 20 of the present invention, thus creating an easier and more consumer friendly interactive shoe 20 according to the present invention. It should be known that any type of rechargeable batteries, such as lithium ion, cadmium or any other type of rechargeable battery known or unknown may be used with the interactive shoe 20 according to the present invention. The electronic components, such as the integrated circuits 46, generally may be arranged within the electronic device 22. However, it is also contemplated to have such components arranged on a bottom portion of the electronic device 22 which may also include the speaker 30 and plurality of buttons 28 arranged therein as one unit.

The electronic device 22 of the present invention may be electrically connected to the power source, in one form a battery, either by wires or wirelessly. The electronic device 22 may also be in electrical communication and connected, via either by a wire or wirelessly, with a plurality of buttons 28 that may be arranged either directly on the electronic device 22 or arranged on a predetermined portion of the tongue 24 or upper 26 of the interactive shoe 20. In one contemplated embodiment, three soft touch buttons 28 are arranged on the tongue 24 of the shoe 20 or on the upper 26 of the shoe 20. In one contemplated embodiment the buttons 28 are arranged on the tongue 24 of the shoe 20 and may be arranged in a triangular pattern near a midpoint of the tongue 24. It should be noted that the buttons 28 may be of any size or shape, other than the circular buttons as shown in the drawings. The buttons 28 may have heart shapes, oval shapes, square shapes, triangular shapes, etc., or any other known shape. In one contemplated embodiment the three buttons 28 may be used for an on/off switch, a volume switch and a skip/play or select switch. It should be noted that any number of buttons 28 may be used and that the three buttons shown in the embodiment is just one contemplated embodiment. It is also contemplated to use one button to control all functions of the electronic device 22 and interactive shoe 20. In one contemplated embodiment, a wire may be arranged between the button 28 and the electronic device 22, which controls the programs on the interactive shoe 20. In one contemplated embodiment, the on/off switch button may be used to turn the interactive shoe 20 either on or off. The volume button 28 may be used to either increase or decrease the volume so it is contemplated that it will be a two way switch that is capable of increasing the volume or decreasing the volume for the user. The skip or select button 28 may allow for the user to skip to the next program/song or play the program that is next in the order of programs being stored or streamed to the electronic device 22. It is also contemplated that pushing the skip or select button 28 a second time may stop or pause the song or program from being played during an interactive portion of the program being played on the interactive shoe 20. As shown in the figures, the buttons 28 may also be arranged on a predetermined portion of the upper 26 of the interactive shoe 20. In the embodiment shown, the plurality of buttons 28 are arranged at or near a midpoint of the upper 26 on one side of the shoe 20. However, it should be noted that the buttons 28 may be arranged on any portion of the upper 26 and on either or both sides of the upper 26 of the shoe 20.

The interactive shoe 20 may also include a speaker 32 either arranged directly within the electronic device 22, such that the electronic device 22 may be an integrated unit which includes a speaker 32, integrated chip 46 and plurality of buttons 28 all arranged in one unit or the speaker 32 may be a separate speaker that is either hardwired or wirelessly connected to the electronic device 22 and be arranged anywhere on any portion of the shoe 20. As shown in the embodiments of the figures, the speaker 32 may be arranged on a predetermined portion of the upper 26 or tongue 24 of the shoe 20. In one embodiment, the speaker 32 is arranged near a front portion of the tongue 24 of the shoe 20 or near a front portion of the upper 26 of the shoe 20 arranged on one side thereof. However, it is also contemplated to use more than one speaker 32 on each shoe 20, such that a speaker 32 may be arranged on each side and a tongue 24 or just on one side. It is also contemplated that the electronic device 22 and associated speaker 32 and buttons 28 may be arranged on both shoes of a pair of shoes or on just one shoe of a pair of shoes depending on the design requirements and the environment in which the interactive shoes 20 may be used. The speakers 32 of the present invention may also be Bluetooth speakers, which are wireless speakers and are capable of streaming music from a phone or other device directly through the shoe 20. It is also contemplated that the speakers 32 may have any known shape, such as a circular shape, an oval shape, a square shape, a heart shape, or any other known shape to be used for the present invention. The speaker 32 may be any type of speaker that is capable of providing a rich and audible sound for the user of the interactive shoe 20 according to the present invention. Generally, the speaker 32 may be made of a plastic material, however it is also contemplated to use any natural material, metal, ceramic, composite or the like to create the speaker 32 and the associated components arranged within the speaker 32 to provide the sound necessary for the interactive shoes 20.

In another contemplated embodiment the interactive shoe 20 may also include a toe cap 36, such as a rubber tip toe cap 36 that may increase the durability for the interactive shoe 20 while also increasing the fun and usability of the shoe 20 by the wearer. The interactive shoe 20 may also use a speaker 32 that is a high definition speaker, thus creating a more full and rich sound for the user of the interactive shoe 20. The electronic device 22 of the interactive shoe 20 may also have different levels, such as level 1, 2, and 3 of a program that teaches exercise, brain games, etc., thus increasing the difficulty of the game being played by the user of the interactive shoe 20. It is also contemplated in one embodiment, to have a plurality of lights 30 arranged at a predetermined position on the interactive shoe 20. In one contemplated embodiment, the plurality of lights 30 are arranged across an entire circumference of an upper top portion of the upper 26 of the shoe 20. These lights 30 are arranged in a linear pattern adjacent to the rubber toe cap 36 of the shoe 20 as shown in the figures. However, it should be known that any number of lights 30 may be arranged in any predetermined pattern anywhere on the upper 26, tongue 24 or sole 34 of the interactive shoe 20 according to the present invention. It should further be noted that the lights 30 of the present invention generally are musical lights that may flash to the beat of the music or song being played through the electronic device 22 of the interactive shoe 26. It should also be noted that the lights 30 may also flash any known color via the use of LED's or incandescent light bulbs known in the art. The lights 30 may be electronically connected to the battery power source of the interactive shoe 20 as described above. It is also contemplated to have the lights 30 powered by its own power source.

In operation, the user or wearer of the interactive shoes 20 may place the shoes 20 and secure them to their feet as with any other normal pair of shoes. The user may then via the buttons 28 turn on the electronic device 22 thus turning on the interactive shoes 20. The user may then select a predetermined program to play on the interactive shoes 20 and adjust the volume accordingly. The interactive programs may be any type of program available and may include the following but not be limited to any known motivational or learning technique, such as motivational speeches, learning songs, fun songs, healthy trait list, brain stimulating games, motor skill and improvement games, and any other type of games that promote fun, any type of exercise regiment, any type of physical therapy regiment, dancing steps, singing lessons, vocal therapy, memory games, riddles, character sounds, fitness program, lullaby songs, nursery rhymes, and/or the ability to teach and learn different languages by the wearer of the shoe 20. The programs as described above may all be interactive and allow for interaction with the user and the interactive shoe 20. It is contemplated that for dance steps, when a proper dance step is completed by the wearer of the shoe 20, the shoe 20 may advance to the next dance step or flash a light or audibly verify that the dance step has been correctly performed. It should also be noted that during use the interactive shoe 20 may be capable of playing any type of music in a hands free manner with no devices or wires having to be connected to the shoe. This may be accomplished via any known phone, computer, or handheld electronic device via a Bluetooth connection between the electronic device 22 and the handheld, phone, etc. It should also be noted that the lights 30 arranged on the interactive shoe 20 may be musical lights that may flash to the beat of the music being played through the electronic device 22 and speakers 32 arranged thereon. It should further be noted that the use of these comfortable interactive play shoes 20 may also include a no skip sound track that allows for the shoes to be used during running or moving activities without the motivational program or songs being played skipping thus effecting the user enjoyment of the device. It is also contemplated to have the interactive shoes 20 be water proof such that they may be used in the rain, during swimming or the like. The use of the easy push on/off volume, and skip buttons 28 may allow for an easy to use interactive shoe 20 that is not difficult for people with limitations, both physical and mental, to properly use the shoes 20 in an interactive manner. It is also contemplated that the shoe 20 may be a slip on, may use Velcro or laces to secure the shoe to the foot of the wearer. It is also contemplated during use that the user may be capable of downloading, streaming or choosing different languages to be used in conjunction with the interactive shoe 20, such that users from different countries may operate the interactive shoe 20 in their native language. It is also contemplated that the electronic device 22 of the interactive shoe 20 may be capable of streaming music directly thereto or other programs thereto via a phone or other handheld electronic device. It is also contemplated that the lights 30 may flash with vibrations from the shoe 20 when the user of the shoes moves or taps the shoe in a predetermined pattern. This vibration lighting may also be used in conjunction with the musical lighting which may flash to the beat of the music.

It is also contemplated to use the shoes 20 as character shoes, which may allow characters, such as Disney characters, Marvels or Universal Studios characters to be a theme for the shoe 20 and to include programs and games associated around such characters to be loaded or streamed onto the electronic device 22 to allow for interactive character play by wearers of the shoes 20. It is also contemplated that different pairs of the interactive shoes 20 according to the present invention may be able to communicate with one another wirelessly such that a group of children may be able to play interactive games relating to a character or non-character programs, thus allowing for a group play environment for the wearers of the interactive shoes 20. It is also contemplated to have a notification to the wearer of the shoe on the status of the battery, thus if the battery is to be completely replaced a tone will sound or a light will flash, and if the battery is a rechargeable if the battery is low and needs to be recharged, a tone may sound or a light will flash telling the wearer of the shoe that the interactive shoe 20 must be recharged or the battery needs to be replaced to continue with enjoyment of the interactive shoe.

The present invention has been described in an illustrative manner. It is to be understood that the terminology which has been used is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. A shoe for use in motivating and teaching the wearer, said shoe comprising:
a sole;
an upper connected to said sole;
a tongue connected at one end to said upper; and
an electronic device arranged in said upper or said tongue, said electronic device plays music, teaches, or motivates the shoe wearer.

2. The shoe of claim 1 further comprising a speaker arranged in said tongue.

3. The shoe of claim 1 further comprising lights, said lights flash to said music.

4. The shoe of claim 2 further comprising at least one button arranged on said tongue.

5. The shoe of claim 4 further comprising a plurality of said buttons, a first of said plurality of buttons is an on/off switch, a second of said plurality of buttons is a volume switch, and a third of said plurality of buttons is a skip/level or songs switch.

6. The shoe of claim 1 further comprising a speaker arranged in said upper.

7. The shoe of claim 6 further comprising at least one button arranged on said tongue.

8. The shoe of claim 7 further comprising a plurality of said buttons, a first of said plurality of buttons is an on/off switch, a second of said plurality of buttons is a volume switch, and a third of said plurality of buttons is a skip level or songs switch.

9. The shoe of claim 1 wherein said electronic device having a speaker and at least one button arranged therein.

10. The shoe of claim 1 wherein said electronic device having an integrated circuit, said integrated circuit is programmable.

11. The shoe of claim 1 wherein the shoe is a slip on and has a hard toe cap.

12. The shoe of claim 1 further comprising a battery, said battery is electronically connected to said electronic device.

13. The shoe of claim 12 wherein said battery is a rechargeable battery.

14. The shoe of claim 5 wherein said buttons are soft touch.

15. The shoe of claim 1 further comprising a plurality of eyelets in said upper, said eyelets receive a shoe lace therein.

16. A method of making and controlling an interactive shoe, said method comprising the steps of:
arranging an electronic device on an upper or tongue of the shoe;
activating said electronic device by pushing an on/off button;
choosing a program stored on or streamed to said electronic device; and
playing said programs through a speaker arranged on said upper or said tongue.

17. The method of claim 16 wherein said electronic device can play said programs in an interactive manner with a wearer of the shoe.

18. The method of claim 16 wherein said program comprises songs, speeches, motivational material, instructional material, motor skill games, or physical therapy directions.

19. The method of claim 16 further comprising the step of adjusting the volume of said speaker with a button on said upper or said tongue.

20. The method of claim 16 further comprising the step of arranging musical lights on said upper or said tongue, said musical lights flash to a beat of a song being played on the interactive shoe.
